(19) United States
(12) Patent Application Publication
(10) Pub. No.: US 2026/0023190 A1
(43) Pub. Date: Jan. 22, 2026

(54) METHOD FOR ADJUSTING MOTOR CONTROL PARAMETERS OF ABSOLUTE GRAVIMETER

(71) Applicant: NATIONAL INSTITUTE OF METROLOGY, CHINA, Beijing (CN)

(72) Inventors: Chunjian LI, Beijing (CN); Shuqing WU, Beijing (CN); Jinyang FENG, Beijing (CN); Dong WANG, Beijing (CN); Qiyu WANG, Beijing (CN); Ruo HU, Beijing (CN); Duowu SU, Beijing (CN); Jiamin YAO, Beijing (CN); Lishuang MOU, Beijing (CN)

(21) Appl. No.: 19/339,369

(22) Filed: Sep. 25, 2025

(30) Foreign Application Priority Data
May 20, 2025 (CN) 202510644794.3

(51) Int. Cl. G01V 7/02

(52) U.S. Cl. CPC G01V 7/02

(57) ABSTRACT

A method for adjusting motor control parameters of an absolute gravimeter is provided, in which a current control phase is determined based on position information, motion information and motion duration of a main drag-free cart and a falling object; a state data is processed using agents to obtain a corresponding action data for adjusting motor control parameters; a reward value is calculated using a reward function; experience data is stored in a replay buffer; the above processes are repeated until a catching phase is reached and the main drag-free cart and the falling object have equal velocities and zero distance; if all agents have completed training, a series of action data is generated using the agents; and if there is an agent has not completed training, corresponding experience data is extracted to continue training, and the absolute gravimeter is reset for iterative execution.

### CROSS-REFERENCE TO RELATED APPLICATIONS

This application claims the benefit of priority from Chinese Patent Application No. 202510644794.3, filed on May 20, 2025. The content of the aforementioned application, including any intervening amendments made thereto, is incorporated herein by reference in its entirety.

### TECHNICAL FIELD

This application relates to motor control, and more particularly to a method for adjusting motor control parameters of an absolute gravimeter.

### BACKGROUND

An absolute gravimeter is a precision metrological instrument designed for direct measurement of gravitational acceleration values on the Earth's surface. During the measurement process using the absolute gravimeter, the motor control of a main drag-free cart consists of three stages: a separation phase, a free-falling phase and a catching phase. In the separation phase, it is essential to ensure smooth and stable separation between the main drag-free cart and the falling object. During the free-falling phase, it is required to maintain relative stillness between the main drag-free cart and the falling object as much as possible. In the catching phase, it is required to make the main drag-free cart “precisely” catch the falling body. The high-precision operational requirements of the absolute gravimeter necessitate the design of a rigorous control strategy for its motor.

The motion control of the motor in absolute gravimeters is typically implemented through a classical proportional-integral-derivative (PID) controller. In the existing techniques, the parameters of the PID controller for such motors are primarily set empirically, and cannot be adaptively adjusted. As a result, conventional methods for adjusting motor control parameters in absolute gravimeters fail to ensure smooth motion of the main drag-free cart and precise free-fall trajectory for the falling object, ultimately leading to reduced measurement accuracy of gravitational acceleration. Therefore, there is an urgent need to address this technical challenge.

### SUMMARY

An object of the disclosure is to provide a method for adjusting motor control parameters of an absolute gravimeter, so as to at least partially solve the above-mentioned problems.

Technical solutions of the present disclosure are described as follows.

In a first aspect, this application provides a method for adjusting motor control parameters of an absolute gravimeter, comprising:
determining a current control phase based on acquired position information, motion information and motion duration of a main drag-free cart and a falling object in a target absolute gravimeter;
based on the current control phase, obtaining a corresponding agent and a corresponding state data, and processing the corresponding state data using the corresponding agent to generate a corresponding action data wherein the corresponding action data is a set of motor controller parameters adjustments;
adjusting motor control parameters of the target absolute gravimeter based on the corresponding action data;
calculating a reward value using a reward function corresponding to the current control phase;
storing the reward value, the corresponding action data, the corresponding state data, and a state data obtained at a next time step as a piece of an experience data in a replay buffer corresponding to the current control phase;
repeating the above steps until the current control phase is a catching phase, the main drag-free cart has the same velocity as the falling object and a distance between the main drag-free cart and the falling object is zero;
based on a preset training termination condition, generating a determination result regarding whether a series of agents have completed training;
if the determination result indicates that all of the series of agents have completed training, processing a state data of the target absolute gravimeter using the series of agents to generate a series of action data, so as to adjust the motor control parameters of the target absolute gravimeter; and
if the determination result indicates that there is a target agent that has not completed training and the number of pieces of experience data in a target replay buffer corresponding to the target agent exceeds a preset threshold, extracting sample experiences from the target replay buffer and training the target agent using the sample experiences to obtain a new target agent; resetting the target absolute gravimeter; and returning to the step of determining the current control phase based on acquired position information, motion information and motion duration of the main drag-free cart and the falling object in the target absolute gravimeter.

In a second aspect, this application provides an apparatus for adjusting motor control parameters of an absolute gravimeter, comprising:
a phase determination module;
an experience collection module;
a training module; and
an adjusting module;
wherein the phase determination module is configured to determine a current control phase based on acquired position information, motion information and motion duration of a main drag-free cart and a falling object in a target absolute gravimeter;
the experience collection module is configured to perform:
obtaining a corresponding agent and a corresponding state data based on the current control phase;
processing the corresponding state data using the corresponding agent to generate a corresponding action data, wherein the corresponding action data comprises a set of motor controller parameter adjustments;
adjusting motor control parameters of the target absolute gravimeter based on the corresponding action data;
calculating a reward value using a reward function corresponding to the current control phase;
storing the reward value, the corresponding action data, the corresponding state data, and a state data obtained at a next time step as a piece of experience data in a replay buffer corresponding to the current control phase, and
repeating the above steps until the current control phase is a catching phase, the main drag-free cart has the same velocity as the falling object and a distance between the main drag-free cart and the falling object is zero;
the training module is configured to perform:
generating a determination result regarding whether a series of agents have completed training based on a preset training termination condition; and
if the determination result indicates that there is a target agent that has not completed training, and the number of pieces of experience data in a target replay buffer corresponding to the target agent exceeds a preset threshold, extracting sample experiences from the target replay buffer, and training the target agent using the sample experiences to obtain a new target agent;
resetting the target absolute gravimeter, and returning to the step of determining the current control phase based on the acquired position information, motion information and motion duration of the main drag-free cart and the falling object in the target absolute gravimeter; and
the adjusting module is configured to perform:
if the determination result indicates that all of the series of agents have completed training, processing a state data of the target absolute gravimeter using the series of agents to generate a series of action data to adjust the motor control parameters of the target absolute gravimeter.

Compared to the prior art, the present disclosure has the following beneficial effects.

By means of the above technical solution, the method and the apparatus for adjusting motor control parameters of the absolute gravimeter provided herein introduce a reinforcement learning framework. For each phase of main drag-free cart control by the motor, the agent and the reward function specifically designed for the phase are first used to accumulate a large amount of experience data, including both successful and failed cases. These experience data are then utilized to train the corresponding agent for each control phase, gradually optimizing the strategies for adjusting controller parameters. Ultimately, the trained agents can dynamically generate precise proportional-integral-derivative (PID) parameter adjustments based on the real-time state data of the target absolute gravimeter. By applying these PID parameters, precise adjustment of the gravimeter motor control parameters can be achieved. Through this interactive learning mechanism, adaptive adjustment of the motor control parameters of the absolute gravimeter is realized, overcoming the limitations of traditional experience-based tuning and significantly improving the accuracy and smoothness of main drag-free cart and falling object motion, thereby enhancing the measurement accuracy of the gravitational acceleration.

The above description is merely an overview of the technical solutions of the present disclosure. In order to more clearly understand the technical means of the present disclosure, the embodiments may be implemented in accordance with the content of the specification. Moreover, to make the above-mentioned and other objectives, features and advantages of the present disclosure more apparent and understandable, specific embodiments of the present disclosure are set forth below.

### BRIEF DESCRIPTION OF THE DRAWINGS

The accompanying drawings are provided to facilitate the understanding of the technical solutions of the present disclosure, and form a part of the specification to illustrate the disclosure together with the embodiments. The accompanying drawings are illustrative and exemplary, and are not intended to limit the disclosure.

FIG. 1 is a flowchart of a method for adjusting motor control parameters of an absolute gravimeter according to an embodiment of the present disclosure;

FIG. 2 is a structural diagram of a free-falling device of the absolute gravimeter according to an embodiment of the present disclosure; and

FIG. 3 is a structural diagram of an apparatus for adjusting motor control parameters of the absolute gravimeter according to an embodiment of the present disclosure.

### DETAILED DESCRIPTION OF EMBODIMENTS

In order to make the objects, technical solutions and advantages of the present disclosure clearer, the present disclosure will be described clearly and completely below in conjunction with the accompanying drawings and embodiments. Obviously, described herein are merely some embodiments of the present disclosure, rather than all embodiments. Based on the embodiments in the present disclosure, all other embodiments obtained by those of ordinary skill in the art without making creative effort shall fall within the scope of the present disclosure defined by the appended claims.

It should be noted that similar reference numerals and letters in the following accompanying drawings indicate similar items. Therefore, once an item has been defined in one drawing, it does not require to further define or explain such item in the subsequent drawings.

As used herein, terms “first” and “second” are merely used to distinguish technical features, rather than indicating or implying their relative importance. It should be understood that, where appropriate, such terms may be used interchangeably, such that the embodiments of the present disclosure described herein can be implemented in orders other than those illustrated or described. In addition, the term “comprising” and its variants are to be interpreted as open-ended terms meaning “including, but not limited to.”

As described above, proportional-integral-derivative (PID) controller parameters of a motor of an absolute gravimeter are primarily set based on experience, and adaptive adjustment cannot be achieved. Therefore, the existing methods for adjusting the motor control parameters of the absolute gravimeter fail to ensure the smoothness of main drag-free cart motion and the accuracy of free-falling of the falling object, resulting in relatively poor accuracy in the measurement of gravitational acceleration. In view of this, the present disclosure proposes a method and an apparatus for adjusting the motor control parameters of the absolute gravimeter, which will be described in detail below by way of the embodiments.

Before describing the embodiments, professional terms involved in the embodiments of the present disclosure are first explained as follows.
1) Environment: In reinforcement learning, the environment refers to the external world in which the agent operates. At each time step, the agent receives state information from the environment, selects an appropriate action, and then the environment provides feedback on the action, including a reward and a new state.
2) State: A current description of the environment.
3) Action: An action is one of the decisions that the agent can take in a given state to maximize the reward in that state. In the present disclosure, an action refers to a control signal output by the agent to control the motor of the absolute gravimeter.
4) Reward: A reward is the feedback provided by the environment after the agent performs a certain action, generally used to evaluate the quality of the action.
5) Time step: Abasic unit of interaction between the agent and the environment. At each time step, the agent takes an action based on the current state, and the environment provides a new state and a reward.

For ease of understanding of the present embodiment, a method for adjusting motor control parameters of an absolute gravimeter disclosed in the embodiments of the present disclosure is first described in detail. The execution subject of the method provided herein is generally a computer device having a certain computing capability. The computer device may include, for example, a terminal device, a server or other processing device. The terminal device may be user equipment (UE), a mobile device, a user terminal or other terminal. In some embodiments, the method provided herein may be implemented by a processor executing computer-readable instructions stored in a memory.

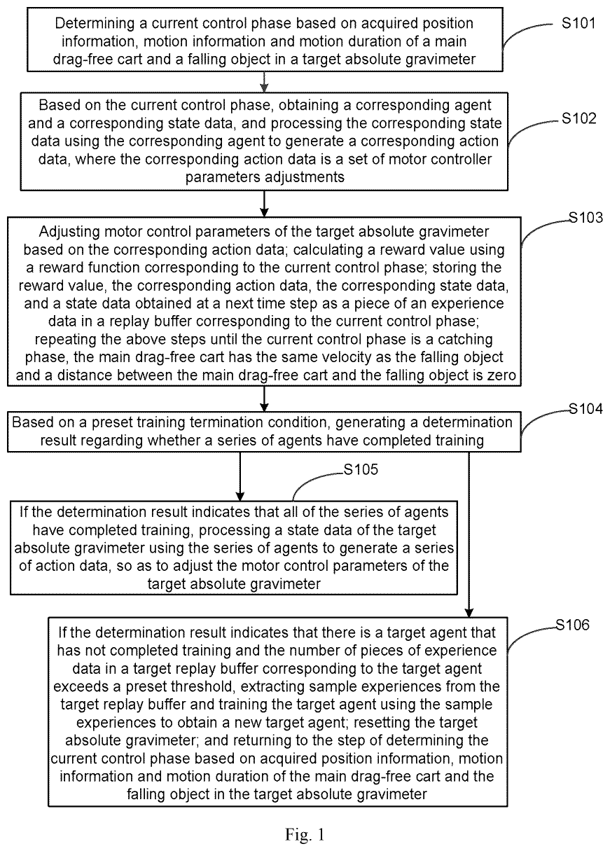

FIG. 1 is a flowchart of the method for adjusting motor control parameters of the absolute gravimeter. As shown in FIG. 1, the method provided herein at least includes steps S101-S106.

(S101) Based on acquired position information, motion information and motion duration of a main drag-free cart and a falling object in a target absolute gravimeter, a current control phase is determined.

(S102) Based on the current control phase, a corresponding agent and a corresponding state data are obtained, and the corresponding state data is processed using the corresponding agent to generate a corresponding action data, where the corresponding action data is a set of motor controller parameters adjustments.

(S103) Motor control parameters of the target absolute gravimeter are adjusted based on the corresponding action data. A reward value is calculated using a reward function corresponding to the current control phase. The reward value, the corresponding action data, the corresponding state data, and a state data obtained at a next time step are stored as a piece of an experience data in a replay buffer corresponding to the current control phase. The above steps are repeated until the current control phase is a catching phase, the main drag-free cart has the same velocity as the falling object and a distance between the main drag-free cart and the falling object is zero.

(S104) Based on a preset training termination condition, a determination result is generated regarding whether a series of agents have completed training.

(S105) If the determination result indicates that the series of agents have completed training, a state data of the target absolute gravimeter is processed using the series of agents to generate a series of action data, so as to adjust the motor control parameters of the target absolute gravimeter.

(S106) If the determination result indicates that there is a target agent has not completed training and the number of pieces of experience data in a target replay buffer corresponding to the target agent exceeds a preset threshold, sample experiences are extracted from the target replay buffer, the target agent is trained using the sample experiences to obtain a new target agent, and the target absolute gravimeter is reset, and step S101 is proceeded to.

The method provided herein introduces a reinforcement learning framework. For each phase of main drag-free cart control by the motor, agents and reward functions specifically designed for the phase are first used to accumulate a large amount of experience data, including both successful and failed cases. These experience data are then utilized to train the agents for each control phase, gradually optimizing their strategies for adjusting controller parameters. Ultimately, the trained agents can dynamically generate precise proportional-integral-derivative (PID) parameter adjustment values based on the real-time state data of the target absolute gravimeter. By applying these PID parameters, precise adjustment of the gravimeter motor control parameters can be achieved. Through this interactive learning mechanism, adaptive adjustment of the motor control parameters of the absolute gravimeter is realized, overcoming the limitations of traditional experience-based tuning and significantly improving the accuracy and smoothness of main drag-free cart and falling object motion, thereby enhancing the measurement accuracy of the gravitational acceleration.

The steps S101-S106 described above are explained in further detail below.

### Regarding Step S101

In this embodiment, training samples, i.e., experience data, are collected. Specifically, in this step, in the target absolute gravimeter, the position information, the motion information and the motion duration of the main drag-free cart and the falling object are acquired. Based on the acquired information, the current control phase is determined. Here, the position information is used to describe the spatial positions of the main drag-free cart and the falling object, which may include, for example, the displacement or vertical coordinates of the main drag-free cart and the falling object in the target absolute gravimeter. The motion information includes instantaneous velocity and instantaneous acceleration. The motion duration refers to the time elapsed since the start of the test in the target absolute gravimeter. As described in the background section, the current control phase includes a separation phase, a free-falling phase and a catching phase.

In this embodiment, no specific limitation is imposed on the manner in which the position information, the motion information and the motion duration of the main drag-free cart and the falling object are obtained. In practice, these may be selected as appropriate based on actual conditions. For example, the apparatus executing the method may be connected to internal sensors of the target absolute gravimeter (such as a laser interferometer for displacement measurement and an accelerometer for acceleration measurement) via a USB or Ethernet interface to read the position information and the motion information of the main drag-free cart and the falling object in real time. A timer module or the internal clock of the gravimeter may be used to obtain the motion duration.

Then, based on the position information, the motion information and the motion duration of the main drag-free cart and the falling object, the current control phase is determined. Specifically, in some embodiments, the motion information includes an instantaneous acceleration of the main drag-free cart, an instantaneous velocity of the main drag-free cart, and an instantaneous velocity of the falling object. The step S101 includes the following steps.

The distance between the main drag-free cart and the falling object is calculated based on the position information of the main drag-free cart and the falling object.

If the distance between the main drag-free cart and the falling object is zero, and the instantaneous acceleration of the main drag-free cart is less than or equal to a gravitational acceleration, the current control phase is determined as the separation phase.

If the motion duration is less than or equal to a preset time threshold, and the instantaneous acceleration of the main drag-free cart is less than or equal to the gravitational acceleration, the current control phase is determined as the free-falling phase.

If the motion duration is greater than the preset time threshold, and the instantaneous velocity of the main drag-free cart is less than or equal to the instantaneous velocity of the falling object, the current control phase is determined as the catching phase.

After the target absolute gravimeter begins testing, the process enters the separation phase, during which the main drag-free cart accelerates downward, and the falling object is smoothly separated from the main drag-free cart when the acceleration exceeds the gravitational acceleration (g). Accordingly, in this phase, the distance between the main drag-free cart and the falling object is zero, and the instantaneous acceleration of the main drag-free cart is less than or equal to the gravitational acceleration. Therefore, in implementation, the distance between the main drag-free cart and the falling object can first be calculated based on the position information of the main drag-free cart and the falling object. For example, the distance may be obtained by subtracting a vertical coordinate of the main drag-free cart from that of the falling object. It is then determined whether the distance between the main drag-free cart and the falling object is zero and whether the instantaneous acceleration of the main drag-free cart is less than or equal to the gravitational acceleration. If both conditions are satisfied, the current control phase is determined as the separation phase.

The process then enters the free-falling phase, during which it is ensured that no external force is applied by the main drag-free cart to the falling object, allowing the falling object to freely fall while the main drag-free cart and the falling object are maintained as nearly stationary relative to each other as possible. After the falling object has freely fallen a certain distance, the process enters the catching phase, during which the main drag-free cart decelerates to smoothly catch the falling object. At the moment of catching, the instantaneous velocities of the main drag-free cart and the falling object should be as close as possible to avoid collision between the falling object and the main drag-free cart. Accordingly, in the free-falling phase, in order to maintain the main drag-free cart and the falling object approximately stationary relative to each other, the initial velocities and accelerations of the main drag-free cart and the falling object are required to be the same. Therefore, at the early phase of free falling, the instantaneous acceleration of the main drag-free cart is initially set to be less than the gravitational acceleration so that its velocity matches that of the falling object. Subsequently, the instantaneous acceleration of the main drag-free cart is set equal to that of the falling object, i.e., both equal to the gravitational acceleration, thereby achieving relative stillness between the main drag-free cart and the falling object. Upon entering the catching phase, to bring the instantaneous velocities of the main drag-free cart and the falling object as close as possible, the main drag-free cart is first decelerated to approach the falling object and then accelerated so that the velocity of the main drag-free cart gradually approaches that of the falling object.

Accordingly, in implementation, it can be determined whether the instantaneous acceleration of the main drag-free cart is less than or equal to the gravitational acceleration and whether the motion duration is less than or equal to the preset time threshold. If both conditions are satisfied, the current control phase is determined as the free-falling phase. It can further be determined whether the motion duration exceeds the preset time threshold and whether the instantaneous velocity of the main drag-free cart is less than or equal to that of the falling object. If both conditions are satisfied, the current control phase is determined as the catching phase.

Here, if the determination based on the relationship between the motion duration and the preset time threshold is not included, misjudgment may occur. This is because, in the catching phase, the instantaneous acceleration of the main drag-free cart may also be less than or equal to the gravitational acceleration (since the main drag-free cart decelerates, its acceleration decreases). Similarly, in the free-falling phase, the instantaneous velocity of the main drag-free cart may also equal that of the falling object (in order to remain relatively stationary with respect to the falling object, the main drag-free cart needs to decelerate first to match the falling object velocity). Accordingly, in this embodiment, the time threshold is used to achieve a unique division of the phases through temporal constraints. In implementation, the time threshold can be set according to actual conditions, and no specific limitation is imposed herein. For example, the time threshold may be set as the duration corresponding to the theoretical end of the free-falling phase.

### Regarding Steps S102-S103

In the present disclosure, each control phase corresponds to its own agent, state data, reward function and replay buffer.

With respect to the agents, the agents in the present disclosure may adopt an actor-critic architecture. In some embodiments, the agents can be lightweighted to meet the real-time requirements of motor control in the absolute gravimeter by, for example, reducing the number of hidden layers or neurons in the actor network, or sharing certain lower-level parameters between two critic networks.

### With Respect to the State Data and the Reward Function

During the separation phase, the motor speed needs to be controlled to accelerate the main drag-free cart downward. Studies have shown that if the main drag-free cart acceleration is too high, the falling object is likely to experience horizontal movement or rotation; if the main drag-free cart acceleration is too low, the falling object cannot be separated from the main drag-free cart.

Accordingly, when the current control phase is the separation phase, in some embodiments, a state data corresponding to the separation phase includes the position information of the main drag-free cart, the position information of the falling object and an instantaneous acceleration of the main drag-free cart.

In some embodiments, the reward function is expressed as:

$${R}_{separation} = - {\sum }_{i = 1}^{T 1} [ \vert {a}_{t} - {a}_{ideal} \vert + {ω}_{falling object} + {v}_{horizontal} ] .$$

In the above equation, Rₛₑₚₐᵣₐₜᵢₒₙ is a reward value for the separation phase, T1 is a preset total number of time steps for the separation phase, aₜ is an actual instantaneous acceleration of the main drag-free cart, a_{ideal} is an ideal instantaneous acceleration of the main drag-free cart in the separation phase, ω_{falling object} is a rotational angular velocity of the falling object, and v_{horizontal} is an instantaneous horizontal velocity of the falling object.

Here, a_{ideal} is preset according to practical requirements. In the present embodiment, the means for obtaining the independent variable values of the reward function are known in the prior art and are not repeated herein.

The separation phase reward function provided in this embodiment incorporates penalty terms such as the deviation of the main drag-free cart's instantaneous acceleration from the ideal value, the rotational angular velocity of the falling object, and the horizontal velocity of the falling object. This design guides the agent for the separation phase to precisely control the motor speed, thereby ensuring that the main drag-free cart acceleration meets the requirements and the falling object separates smoothly, avoiding separation failure or motion deviation caused by improper acceleration.

During the free-falling phase, the motor speed needs to be controlled to ensure that the main drag-free cart and the falling object remain as relatively stationary as possible. Accordingly, when the current control phase is determined as the free-falling phase, in some embodiments, a state data corresponding to the free-falling phase includes the position information of the main drag-free cart, the position information of the falling object, the instantaneous velocity of the main drag-free cart, the instantaneous velocity of the falling object, and the instantaneous acceleration of the main drag-free cart.

In some embodiments, the reward function is expressed as:

$${R}_{free - fall} = - {\sum }_{i = 1 + T 1}^{T 2} [ \vert {x}_{main drag - free cart} - {x}_{falling object} - A \vert + \vert {v}_{t} - {v}_{ideal} \vert ] .$$

In the above equation, R_{free-fall} is a reward value for the free-falling phase, T2-T1-1 is a preset total number of time steps for the free-falling phase, x_{main drag-free cart} is the position information of the main drag-free cart, x_{falling object} is the position information of the falling object, A is a preset ideal distance between the main drag-free cart and the falling object, vₜ is an actual instantaneous velocity of the main drag-free cart, and v_{ideal} is a preset ideal instantaneous velocity of the main drag-free cart.

During implementation, A can be set according to actual requirements, and this embodiment does not impose a limitation thereon. For example, A may be set to 3 mm. The means for obtaining the independent variable values in the free-falling phase reward function are known in the prior art and are not further described herein.

The free-falling phase reward function provided in this embodiment introduces penalty terms such as the deviation between the actual and ideal distances between the main drag-free cart and the falling object, and the velocity deviation between the main drag-free cart and the falling object. These penalty terms guide the free-falling phase agent to precisely adjust the motor speed, ensuring that the main drag-free cart and the falling object remain relatively stationary, and preventing significant position or velocity deviations from causing a departure from the ideal motion state, thereby meeting the requirements for high-precision control.

In the catching phase, it is necessary to control the motor speed so that the main drag-free cart decelerates gradually and “just” catches the falling object, with the instantaneous velocities of the main drag-free cart and the falling object being as close as possible to each other to avoid collisions. Based on this, when the current control phase is determined as the catching phase, in some embodiments, a state data corresponding to the catching phase includes the position information of the main drag-free cart, the position information of the falling object, the instantaneous velocity of the main drag-free cart, the instantaneous velocity of the falling object and the instantaneous acceleration of the main drag-free cart.

In some embodiments, the reward function is expressed as:

$${R}_{catch} = - {\sum }_{i = 1 + T 2}^{T 3} [ \vert {v}_{main drag - free cart at catch} - {v}_{falling object at catch} \vert + \vert {v}_{t} - {v}_{ideal} \vert ] .$$

In the above equation, R_{catch} is a reward value for the catching phase, T3-T2-1 is a preset total number of time steps for the catching phase, v_{main drag-free cart at catch} is an instantaneous velocity of the main drag-free cart at a moment when the main drag-free cart catches the falling object, and v_{falling object at catch} is an instantaneous velocity of the falling object at the moment when the falling object is caught by the main drag-free cart.

Here, the means for obtaining the variable values in the catching phase reward function are known in the prior art and are not further described herein.

The catching phase reward function provided in this embodiment introduces penalty terms such as the instantaneous velocity difference between the main drag-free cart and the falling object at catch (to ensure velocities are close and avoid collisions) and the deviation of the main drag-free cart velocity from the ideal velocity (to control the smoothness of deceleration). These penalty terms guide the agent in the catching phase to precisely adjust the motor speed, enabling the main drag-free cart to decelerate along the ideal velocity profile and achieve the control objective of “just catching” the falling object.

Studies have shown that the main drag-free cart motion trajectory of the absolute gravimeter can deviate from its ideal state due to self-oscillations of a transmission mechanism caused by mechanical friction and other excitations. In addition, as a key transmission component driving the main drag-free cart, a steel belt can undergo minute deformations due to temperature changes, and the accumulation of these deformations can also lead to systematic deviations in the main drag-free cart motion path. Both types of deviations may cause the motor feedback control system to generate adjustment errors, ultimately resulting in reduced control accuracy. Therefore, the self-oscillation characteristics of the transmission mechanism and the temperature stability of the steel belt are two critical factors affecting the precision of motor control.

Based on this, in some embodiments, when the current control phase is the separation phase, the state data corresponding to the separation phase includes the position information of the main drag-free cart, the position information of the falling object, the instantaneous acceleration of the main drag-free cart, and at least one of the following: a natural main frequency peak of a transmission mechanism in the target absolute gravimeter, and temperature variation data of the steel belt in the target absolute gravimeter. When the current control phase is the free-falling phase or the catching phase, the state data corresponding to the free-falling phase or the catching phase includes the position information of the main drag-free cart, the position information of the falling object, the instantaneous velocity of the main drag-free cart, the instantaneous velocity of the falling object, the instantaneous acceleration of the main drag-free cart, and at least one of the following: a natural main frequency peak of the transmission mechanism in the target absolute gravimeter, and temperature variation data of the steel belt in the target absolute gravimeter.

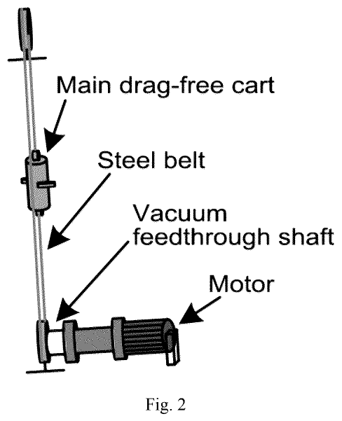

In this embodiment, with respect to the transmission mechanism of the target absolute gravimeter, for illustration, FIG. 2 shows a structural diagram of a free-falling device of the absolute gravimeter. As shown in FIG. 2, the free-falling device mainly includes a main drag-free cart, a steel belt, a vacuum feedthrough shaft and a motor. Among them, the steel belt, the vacuum feedthrough shaft and the motor together form the transmission mechanism.

In order to obtain the natural main frequency peak of the transmission mechanism, during implementation, an acceleration sensor (e.g., a piezoelectric accelerometer) can be installed on key components of the transmission mechanism, such as the steel belt, the main drag-free cart or the vacuum feedthrough shaft. The analog vibration signal output by the acceleration sensor is converted into a digital signal using a data acquisition card. Subsequently, the collected time-domain signal is preprocessed through software (e.g., MATLAB or LabVIEW) by filtering and amplification. A fast Fourier transform (FFT) algorithm is applied to convert the time-domain vibration signal into a frequency-domain signal, generating a frequency spectrum. In the frequency spectrum, the frequency corresponding to the peak with the highest amplitude represents the natural main frequency peak.

To obtain the temperature variation data of the steel belt, during implementation, a temperature sensor can be fixed on the steel belt. The temperature sensor can acquire temperature data in real time, and based on adjacent temperature data points, the temperature variation data can be calculated.

In this embodiment, by incorporating the natural main frequency peak of the transmission mechanism and/or the temperature variation data of the steel belt into the state data for each control phase, the state space covers both the mechanical vibration characteristics and the thermal characteristics of the gravimeter. This provides the agents with precise environmental feedback, enabling them to learn optimal control strategies under the interaction of multiple factors, reducing main drag-free cart motion deviations caused by mechanical friction excitations and cumulative thermal deformation, and significantly improving the response accuracy and robustness of the motor feedback control.

In some embodiments, the above-mentioned reward functions further include the natural main frequency peak of the transmission mechanism in the target absolute gravimeter.

Specifically, when the current control phase is determined as the separation phase, the reward function is expressed as:

$${R}_{separation} = - {\sum }_{i = 1}^{T} [ \vert {a}_{t} - {a}_{ideal} \vert + {ω}_{falling object} + {v}_{horizontal} + {A}_{natural main frequency peak} ] .$$

In the above equation, A_{natural main frequency peak} is the natural main frequency peak of the transmission mechanism.

When the current control phase is determined as the free-falling phase, the reward function is expressed as:

$${R}_{free - fall} = - {\sum }_{i = 1}^{T} [ \vert {x}_{main drag - free cart} - {x}_{falling object} - 3 mm \vert + \vert {v}_{t} - {v}_{ideal} \vert + {A}_{natural main frequency peak} ] .$$

When the current control phase is determined as the catching phase, the reward function is expressed as:

$${R}_{catch} = - {\sum }_{i = 1}^{T} [ \vert {v}_{main drag - free cart at catch} - {v}_{falling object at catch} \vert + \vert {v}_{t} - {v}_{ideal} \vert + {A}_{natural main frequency peak} ] .$$

In this embodiment, besides focusing on their respective core control objectives, the reward functions for each phase also take into account the self-oscillation interference of the transmission mechanism. This enables each agent to generate more precise PID parameter adjustment strategies, further enhancing the reliability of the motor control of the absolute gravimeter.

After the corresponding agent, the corresponding state data and the reward function have been determined based on the current control phase, the corresponding agent can first process the corresponding state data to generate the corresponding action data. Here, the corresponding action data, i.e., the PID controller parameter adjustments, correspond to the weights of the actor network in the agent. Based on the corresponding action data, the motor control parameters are adjusted. Next, the corresponding reward function is used to calculate a reward value. The state data at a next time step is then obtained. The reward value, the corresponding action data, the corresponding state data at the current time step, and the state data at the next time step together constitute a piece of an experience data, which is stored in the replay buffer corresponding to the current control phase. This process is repeated at each time step according to steps S101-S103 to collect experience data until the current control phase reaches the catching phase and the main drag-free cart and the falling object have the same velocity with the distance between the main drag-free cart and the falling object is zero, i.e., the catching phase ends. At this point, one episode of experience data collection is completed.

### Regarding Steps S104-S106

Here, the training termination condition may be, for example, convergence of the reward function, or reaching a preset number of training episodes. The training termination condition may be set as needed, and is not limited in the embodiments of the present disclosure.

It may be determined whether all of the agents satisfy the preset training termination condition. If all the agents satisfy the preset training termination condition, this indicates that the performance of each agent has reached the required level. At this point, the state data of the target absolute gravimeter is input into the agents to generate a set of motor controller parameters adjustments. By using the set of motor controller parameters adjustments, the motor control parameters of the target absolute gravimeter are adjusted.

If it is determined that there is a target agent that has not completed training, and the number of pieces of experience data in the target replay buffer corresponding to the target agent exceeds the preset threshold, sample experiences are extracted from the target replay buffer. In implementation, random sampling may be performed in the target replay buffer to obtain a plurality of sample experiences, which are then used to train the target agent, thereby obtaining the new target agent. Here, the preset threshold may be set as needed. Next, the target absolute gravimeter is reset (the resetting operation including resetting the main drag-free cart and the falling object to their initial positions, clearing the control parameters and the state data), such that the system restarts from a unified initial condition to ensure training consistency. The process then returns to step S101 and iterates continuously until all the agents satisfy the preset training termination condition.

It should be understood by those skilled in the art that, in the foregoing method of the embodiments, the order in which the steps are written does not imply a strict execution sequence nor impose any limitation on the implementation process. The specific execution order of the steps should be determined based on their functions and possible inherent logic.

It should be noted that, in practical applications, all of the above possible embodiments may be combined in any manner to form possible embodiments of the present disclosure, which will not be described in detail herein.

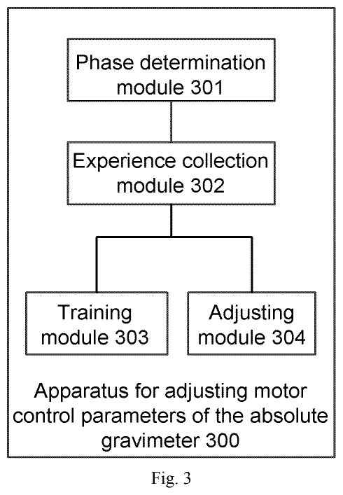

Based on the same concept, the present disclosure also provides an apparatus for adjusting motor control parameters of an absolute gravimeter. The apparatus corresponds one-to-one with the method described above. FIG. 3 illustrates a structural diagram of the apparatus for adjusting the motor control parameters of the absolute gravimeter. Referring to FIG. 3, the apparatus 300 provided herein includes a phase determination module 301, an experience collection module 302, a training module 303 and an adjusting module 304.

The phase determination module 301 is configured to determine a current control phase based on acquired position information, motion information and motion duration of a main drag-free cart and a falling object in a target absolute gravimeter.

The experience collection module 302 is configured to perform:
obtaining a corresponding agent and a corresponding state data based on the current control phase;
processing the corresponding state data using the corresponding agent to generate a corresponding action data, wherein the corresponding action data comprises a set of motor controller parameter adjustments;
adjusting motor control parameters of the target absolute gravimeter based on the corresponding action data;
calculating a reward value using a reward function corresponding to the current control phase;
storing the reward value, the corresponding action data, the corresponding state data, and a state data obtained at a next time step as a piece of experience data in a replay buffer corresponding to the current control phase, and
repeating the above steps until the current control phase is a catching phase, the main drag-free cart has the same velocity as the falling object and a distance between the main drag-free cart and the falling object is zero.

The training module 303 is configured to perform:
generating a determination result regarding whether a series of agents have completed training based on a preset training termination condition; and
if the determination result indicates that there is a target agent that has not completed training, and the number of pieces of experience data in a target replay buffer corresponding to the target agent exceeds a preset threshold, extracting sample experiences from the target replay buffer, and training the target agent using the sample experiences to obtain a new target agent;
resetting the target absolute gravimeter, and return to the step S101.

The adjusting module 304 is configured to perform:
if the determination result indicates that all of the series of agents have completed training, processing a state data of the target absolute gravimeter using the series of agents to generate a series of action data to adjust the motor control parameters of the target absolute gravimeter.

In some embodiments, the motion information includes an instantaneous acceleration of the main drag-free cart, an instantaneous velocity of the main drag-free cart and an instantaneous velocity of the falling object. In the above apparatus, the phase determination module 301 is specifically configured to calculate a distance between the main drag-free cart and the falling object based on the position information of the main drag-free cart and the falling object. If the distance between the main drag-free cart and the falling object is 0 and the instantaneous acceleration of the main drag-free cart is less than or equal to a gravitational acceleration, the phase determination module 301 is configured to determine that the current control phase is a separation phase; if the motion duration is less than or equal to a preset time threshold and the instantaneous acceleration of the main drag-free cart is less than or equal to the gravitational acceleration, the phase determination module 301 is configured to determine that the current control phase is a free-falling phase; and if the motion duration is greater than the preset time threshold and the instantaneous velocity of the main drag-free cart is less than or equal to the instantaneous velocity of the falling object, the phase determination module 301 is configured to determine that the current control phase is the catching phase.

In some embodiments, in the above apparatus, if the current control phase is determined as the separation phase, the state data corresponding to the separation phase includes the position information of the main drag-free cart, the position information of the falling object and the instantaneous acceleration of the main drag-free cart.

In some embodiments, in the above apparatus, if the current control phase is determined as the free-falling phase or the catching phase, the state data corresponding to the free-falling phase or the catching phase includes the position information of the main drag-free cart, the position information of the falling object, the instantaneous velocity of the main drag-free cart, the instantaneous velocity of the falling object and the instantaneous acceleration of the main drag-free cart.

In some embodiments, when the current control phase is determined as the separation phase, the reward function is expressed as:

$${R}_{separation} = - {\sum }_{i = 1}^{T 1} [ \vert {a}_{t} - {a}_{ideal} \vert + {ω}_{falling object} + {v}_{horizontal} ] .$$

In the above equation, Rₛₑₚₐᵣₐₜᵢₒₙ is a reward value for the separation phase, T1 is a preset total number of time steps for the separation phase, aₜ is an actual instantaneous acceleration of the main drag-free cart, a_{ideal} is an ideal instantaneous acceleration of the main drag-free cart in the separation phase, ω_{falling object} is a rotational angular velocity of the falling object, and v_{horizontal} is the instantaneous horizontal velocity of the falling object.

In some embodiments, when the current control phase is determined as the free-falling phase, the reward function is expressed as:

$${R}_{free - fall} = - {\sum }_{i = 1 + T 1}^{T 2} [ \vert {x}_{main drag - free cart} - {x}_{falling object} - A \vert + \vert {v}_{t} - {v}_{ideal} \vert ] .$$

In the above equation, R_{free-fall} is a reward value for the free-falling phase, T2-T1-1 is a preset total number of time steps for the free-falling phase, x_{main drag-free cart} is the position information of the main drag-free cart, x_{falling objects} is the position information of the falling object, A is a preset ideal distance between the main drag-free cart and the falling object, vₜ is the actual instantaneous velocity of the main drag-free cart, and v_{idea} is a preset ideal instantaneous velocity of the main drag-free cart.

In some embodiments, when the current control phase is determined as the catching phase, the reward function is expressed as:

$${R}_{catch} = - {\sum }_{i = 1 + T 2}^{T 3} [ \vert {v}_{main drag - free cart at catch} - {v}_{falling object at catch} \vert + \vert {v}_{t} - {v}_{ideal} \vert ] .$$

In the above equation, R_{catch} is a reward value for the catching phase, T3-T2-1 is a preset total number of time steps for the catching phase, v_{main drag-free cart at catch} is the instantaneous velocity of the main drag-free cart at a moment when the main drag-free cart catches the falling object, v_{failing object at catch} is the instantaneous velocity of the falling object at the moment when the falling object is caught by the main drag-free cart, vₜ is the actual instantaneous velocity of the main drag-free cart, and v_{ideal} is a preset ideal instantaneous velocity of the main drag-free cart.

In some embodiments, in the above apparatus, if the current control phase is determined as the separation phase, the state data includes the position information of the main drag-free cart, the position information of the falling object, the instantaneous acceleration of the main drag-free cart, and at least one of the following: a natural main frequency peak of a transmission mechanism in the target absolute gravimeter, and temperature variation data of a steel belt in the target absolute gravimeter. If the current control phase is determined as the free-falling phase or the catching phase, the state data includes the position information of the main drag-free cart, the position information of the falling object, the instantaneous velocity of the main drag-free cart, the instantaneous velocity of the falling object, the instantaneous acceleration of the main drag-free cart, and at least one of the following: the natural main frequency peak of the transmission mechanism in the target absolute gravimeter, and temperature variation data of the steel belt in the target absolute gravimeter.

In some embodiments, in the above apparatus, the reward function further includes the natural main frequency peak of the transmission mechanism in the target absolute gravimeter.

The apparatus provided herein introduces a reinforcement learning framework. For each phase of main drag-free cart control by the motor, agents and reward functions specifically designed for each phase are first used to accumulate a large amount of experience data, including both successful and failed cases. These experience data are then utilized to train the agents for each control phase, gradually optimizing their strategies for adjusting controller parameters. Ultimately, the trained agents can dynamically generate precise PID parameter adjustment values based on the real-time state data of the target absolute gravimeter. By applying these PID parameters, precise adjustment of the gravimeter motor control parameters can be achieved. Through this interactive learning mechanism, adaptive adjustment of the motor control parameters of the absolute gravimeter is realized, overcoming the limitations of traditional experience-based tuning and significantly improving the accuracy and smoothness of main drag-free cart and falling object motion, thereby enhancing the measurement accuracy of the gravitational acceleration.

The apparatus provided herein may be specifically limited in the same manner as the method described above, and such details are not repeated herein. Each module of the above apparatus may be implemented entirely or partially by software, hardware or a combination thereof. The modules may be embedded in or independent from the processor of a computer device in a hardware form, or stored in a memory of the computer device in a software form, such that the processor can invoke and execute the operations corresponding to each module.

It should be noted that, the terms “comprise”, “include” or any other variants thereof are intended to cover non-exclusive inclusion, such that a process, method, article, or apparatus that comprises a list of elements does not include only those elements, but may also include other elements not expressly listed or elements inherent to such process, method, article, or apparatus. In the absence of additional limitations, an element defined by the phrase “comprising a . . . ” does not exclude the presence of additional elements of the same type in a process, method, article, or apparatus that comprises the stated element.

Those skilled in the art should be understand that the embodiments of the present disclosure may be provided in the form of a method, a system or a computer program product. Accordingly, the present disclosure may be implemented entirely in hardware, entirely in software or in a combination thereof. Furthermore, the present disclosure may take the form of a computer program product implemented on one or more computer-readable storage media containing computer-usable program code (including, but not limited to, magnetic storage media, Compact Disc-Read-Only Memory (CD-ROM) and optical storage media).

Described embodiments are merely illustrative, and are not intended to limit the scope of the present disclosure. It should be understood that various modifications, changes and replacements made by those skilled in the art without departing from the spirit of the disclosure shall fall within the scope of the present disclosure defined by the appended claims.

What is claimed is:

1. A method for adjusting motor control parameters of an absolute gravimeter, comprising:
determining a current control phase based on acquired position information, motion information and motion duration of a main drag-free cart and a falling object in a target absolute gravimeter;
based on the current control phase, obtaining a corresponding agent and a corresponding state data, and processing the corresponding state data using the corresponding agent to generate a corresponding action data, wherein the corresponding action data is a set of motor controller parameter adjustments;
adjusting motor control parameters of the target absolute gravimeter based on the corresponding action data;
calculating a reward value using a reward function corresponding to the current control phase;
storing the reward value, the corresponding action data, the corresponding state data, and a state data obtained at a next time step as a piece of an experience data in a replay buffer corresponding to the current control phase;
repeating the above steps until the current control phase is a catching phase, the main drag-free cart has the same velocity as the falling object, and a distance between the main drag-free cart and the falling object is zero;
based on a preset training termination condition, generating a determination result regarding whether a series of agents have completed training;
if the determination result indicates that all of the series of agents have completed training, processing a state data of the target absolute gravimeter using the series of agents to generate a series of action data, so as to adjust the motor control parameters of the target absolute gravimeter; and
if the determination result indicates that there is a target agent that has not completed training, and the number of pieces of experience data in a target replay buffer corresponding to the target agent exceeds a preset threshold, extracting sample experiences from the target replay buffer and training the target agent using the sample experiences to obtain a new target agent; resetting the target absolute gravimeter; and returning to the step of determining the current control phase based on acquired position information, motion information and motion duration of the main drag-free cart and the falling object in the target absolute gravimeter.

2. The method of claim 1, wherein the acquired motion information comprises an instantaneous acceleration of the main drag-free cart, an instantaneous velocity of the main drag-free cart and an instantaneous velocity of the falling object; and
the step of determining the current control phase based on the acquired position information, motion information and motion duration of the main drag-free cart and the falling object in the target absolute gravimeter comprises:
calculating the distance between the main drag-free cart and the falling object based on the position information of the main drag-free cart and the falling object;
if the distance between the main drag-free cart and the falling object is zero, and the instantaneous acceleration of the main drag-free cart is less than or equal to a gravitational acceleration, determining the current control phase as a separation phase;
if the motion duration is less than or equal to a preset time threshold, and the instantaneous acceleration of the main drag-free cart is less than or equal to the gravitational acceleration, determining the current control phase as a free-falling phase; and
if the motion duration is greater than the preset time threshold, and the instantaneous velocity of the main drag-free cart is less than or equal to the instantaneous velocity of the falling object, determining the current control phase as a catching phase.

3. The method of claim 1, wherein when the current control phase is determined as a separation phase, a first state data corresponding to the separation phase comprises the position information of the main drag-free cart, the position information of the falling object and an instantaneous acceleration of the main drag-free cart.

4. The method of claim 1, wherein when the current control phase is determined as a free-falling phase or a catching phase, a state data corresponding to the free-falling phase or the catching phase comprises the position information of the main drag-free cart, the position information of the falling object, an instantaneous velocity of the main drag-free cart, an instantaneous velocity of the falling object and an instantaneous acceleration of the main drag-free cart.

5. The method of claim 1, wherein when the current control phase is determined as a separation phase, the reward function is expressed as:
$${R}_{separation} = - {\sum }_{i = 1}^{T 1} [ \vert {a}_{t} - {a}_{ideal} \vert + {ω}_{falling object} + {v}_{horizontal} ] .$$
wherein Rₛₑₚₐᵣₐₜᵢₒₙ is a reward value for the separation phase, T1 is a preset total number of time steps for the separation phase, aₜ is an actual instantaneous acceleration of the main drag-free cart, a_{ideal} is an ideal instantaneous acceleration of the main drag-free cart in the separation phase, ω_{falling object} is a rotational angular velocity of the falling object, and v_{horizontal} is an instantaneous horizontal velocity of the falling object.

6. The method of claim 1, wherein when the current control phase is determined as a free-falling phase, the reward function is expressed as:
$${R}_{free - fall} = - {\sum }_{i = 1 + T 1}^{T 2} [ \vert {x}_{main drag - free cart} - {x}_{falling object} - A \vert + \vert {v}_{t} - {v}_{ideal} \vert ] ;$$
wherein R_{free-fall} is a reward value for the free-falling phase, T2-T1-1 is a preset total number of time steps for the free-falling phase, x_{main drag-free cart} is the position information of the main drag-free cart, x_{falling object} is the position information of the falling object, A is a preset ideal distance between the main drag-free cart and the falling object, vₜ is an actual instantaneous velocity of the main drag-free cart, and v_{ideal} is a preset ideal instantaneous velocity of the main drag-free cart.

7. The method of claim 1, wherein when the current control phase is determined as a catching phase, the reward function is expressed as:
$${R}_{catch} = - {\sum }_{i = 1 + T 2}^{T 3} [ \vert {v}_{main drag - free cart at catch} - {v}_{falling object at catch} \vert + \vert {v}_{t} - {v}_{ideal} \vert ] ;$$
wherein R_{catch} is a reward value for the catching phase, T3-T2-1 is a preset total number of time steps for the catching phase, v_{main drag-free cart at catch} is an instantaneous velocity of the main drag-free cart at a moment when the main drag-free cart catches the falling object, v_{falling object at catch} is an instantaneous velocity of the falling object at the moment when the falling object is caught by the main drag-free cart, vₜ is an actual instantaneous velocity of the main drag-free cart, and v_{ideal} is a preset ideal instantaneous velocity of the main drag-free cart.

8. The method of claim 3, wherein the state data corresponding to the separation phase further comprises a natural main frequency peak of a transmission mechanism in the target absolute gravimeter, temperature variation data of a steel belt in the target absolute gravimeter or a combination thereof.

9. The method of claim 4, wherein the state data corresponding to the free-falling phase or the catching phase further comprises a natural main frequency peak of a transmission mechanism in the target absolute gravimeter, temperature variation data of a steel belt in the target absolute gravimeter or a combination thereof.

10. The method of claim 5, wherein the reward function further comprises a natural main frequency peak of a transmission mechanism in the target absolute gravimeter.

11. The method of claim 6, wherein the reward function further comprises a natural main frequency peak of a transmission mechanism in the target absolute gravimeter.

12. The method of claim 7, wherein the reward function further comprises a natural main frequency peak of a transmission mechanism in the target absolute gravimeter.

13. An apparatus for adjusting motor control parameters of an absolute gravimeter, comprising:
a phase determination module;
an experience collection module;
a training module; and
an adjusting module;
wherein the phase determination module is configured to determine a current control phase based on acquired position information, motion information and motion duration of a main drag-free cart and a falling object in a target absolute gravimeter;
the experience collection module is configured to perform:
obtaining a corresponding agent and a corresponding state data based on the current control phase;
processing the corresponding state data using the corresponding agent to generate a corresponding action data, wherein the corresponding action data comprises a set of motor controller parameter adjustments;
adjusting motor control parameters of the target absolute gravimeter based on the corresponding action data;
calculating a reward value using a reward function corresponding to the current control phase;
storing the reward value, the corresponding action data, the corresponding state data, and a state data obtained at a next time step as a piece of experience data in a replay buffer corresponding to the current control phase; and
repeating the above steps until the current control phase is a catching phase, the main drag-free cart has the same velocity as the falling object, and a distance between the main drag-free cart and the falling object is zero;
the training module is configured to perform:
generating a determination result regarding whether a series of agents have completed training based on a preset training termination condition; and
if the determination result indicates that there is a target agent that has not completed training, and the number of pieces of experience data in a target replay buffer corresponding to the target agent exceeds a preset threshold, extracting sample experiences from the target replay buffer, and training the target agent using the sample experiences to obtain a new target agent;
resetting the target absolute gravimeter, and returning to the step of determining the current control phase based on the acquired position information, motion information and motion duration of the main drag-free cart and the falling object in the target absolute gravimeter; and
the adjusting module is configured to perform:
if the determination result indicates that all of the series of agents have completed training, processing a state data of the target absolute gravimeter using the series of agents to generate a series of action data, so as to adjust the motor control parameters of the target absolute gravimeter.
